(19) United States
(12) Patent Application Publication
(10) Pub. No.: US 2004/0086321 A1
(43) Pub. Date: May 6, 2004

(54) Aerosol patient preparatory applicator

(76) Inventors: Jonathan Karl Burkholz, Salt Lake City, UT (US); Minh Quang Hoang, Taylorsville, UT (US)

Correspondence Address: BECTON, DICKINSON AND COMPANY, 1 BECTON DRIVE, FRANKLIN LAKES, NJ, 07417-1880, US

(21) Appl. No.: 10/285,981

(22) Filed: Nov. 1, 2002

(51) Int. Cl. B05C 11/00; B05C 17/005

(52) U.S. Cl. 401/190; 401/205; 401/266

(57) ABSTRACT

An applicator for an anti-microbial solution includes an aerosol container and an applicator pad assembly having a hollow arm. The hollow arm has a proximal end attached to an aerosol cap and a distal end having a flanged arm plate to receive a foam applicator pad. The aerosol cap is removably attached to the aerosol container. A solution flow control is in communication with the aerosol container for selectively dispensing the anti-microbial solution. The aerosol container holds the anti-microbial solution under pressure and flow is controlled by a pressure-sensitive flow control tab. The control tab activates the flow of the anti-microbial solution from the aerosol container through the hollow handle to the foam pad and then to the patient. The control tab may be actuated by touch or by pressure applied to the applicator pad. An optional flow control feature, in addition to the control tab, is a slit formed in the foam pad. The slit is designed so that it remains closed when no pressure is exerted on the distal surface of the foam pad. However, when pressure is exerted on the distal surface of the foam pad, such as when the applicator is pressed against a patient's skin, the slit opens to allow the anti-microbial solution to flow past the slit into the foam pad. There the anti-microbial solution can be easily distributed over the patient's skin by the foam pad. When a sufficient amount of the anti-microbial solution has flowed into the foam pad, the healthcare professional can release the pressure sensitive control tab to stop the flow of anti-microbial solution out of the aerosol container.

### BACKGROUND OF THE INVENTION

1. Field of the Invention

The present invention relates to a device and method for applying an antimicrobial solution to a patient's skin, and more particularly to an aerosol type applicator that consists of a pressurized rigid metallic container having an alcohol or non-alcohol based antimicrobial solution. The metallic container utilizes a multi-component valve assembly for dispensing the solution as a liquid or foam for skin disinfection, patient preparation.

2. Description of Relevant Art

Because microorganisms lie on the skin, standard invasive medical procedures require the patient's skin, where the procedure is to take place, to be disinfected prior to the procedure. This skin preparation is important in order to minimize the risk of infection to the patient.

Alcohol has long been recognized as a fast acting broad-spectrum disinfectant. Alcohol-based prep solutions have many advantages over soap or water based prep solutions, such as reduced prepping and solution drying time. However, alcohol is flammable and its use and application on a patient must be carefully controlled in order to minimize the fire hazard created when such an alcohol-based prep solution is used. Indeed, in its January 1992 Guidance on Surgical Fires, the ECRI, (formerly the Emergency Care Research Institute) stated that approximately ten surgical patient fires come to its attention per year. Most of these fires ignite on or in the patient and obviously can cause considerable injury to the patient. The ECRI estimates that this problem is more severe than the numbers would indicate because it believes that numerous other unreported fires occur. This problem is exacerbated since today's surgical suites and other patient care facilities include a significant number of electrical devices that may come in contact with the patient. For example, such electrical devices include patient monitoring equipment, electrosurgical or electrocautery devices, defibrillators, heated probes, drills, argon beam coagulators, fiber-optic light sources and cables and lasers, which all may be used on and around the patient. In addition, the atmosphere in surgical suites and other patient care facilities is made more combustible because of the common use of oxygen.

Many different antimicrobial applicators exist but could be improved. First generation applicators, as depicted in U.S. Pat. No. 4,183,684, allow the applicator contents to flow in large uncontrolled amounts. The volume of solution applied at any one time is governed only by the physical properties of the solution and the size and absorption properties of foam applicator pads attached to the distal contact-end of the applicator. This type of applicator is problematic because it may allow excessive amounts of the antimicrobial solution to flow onto the patient where it could pool and create a significant fire hazard if the antimicrobial solution is flammable. This is due in large part because the design relies on gravity and the free flow of solution from the applicator to the foam application pads to dispense the applicator contents. As a consequence, if the applicator is not positioned to prevent solution flow, unwanted residual solution will continue to leak onto the applicator pad. In addition, even when the applicator is positioned to prevent solution flow, the free communication between the solution storage and the foam applicator will allow fumes to continue to escape into the operating environment. Furthermore, a patient is often covered by a surgical cloth drape after the disinfecting procedure takes place. When dispensation of the solution is not sufficiently controlled a significant amount of the antimicrobial solution may collect on the surgical drape. Again, if the antimicrobial solution is flammable a potential exists for a severe accident to the patient and the healthcare professionals in the area. Also, this inability to adequately control the flow of antimicrobial solution on and around the patient increases the likelihood that the solution will stain material in the area.

### 3. SUMMARY OF THE INVENTION

It is therefore an object of the invention to provide an applicator for an antimicrobial solution that controls the amount of solution dispensed from the applicator.

It is another object of this invention to provide an applicator for an antimicrobial solution that allows the user to stop the flow of solution when desired.

Still another object of this invention is to provide an applicator for an antimicrobial solution that allows the solution to remain in the applicator after some of the solution has been dispensed for subsequent use or disposal.

It is still another object of this invention to provide an applicator for an antimicrobial solution that allows the solution and its vapors to no longer communicate with the operating room environment when the solution dispensing mechanism is closed.

It is still another object of this invention to provide an applicator for an antimicrobial solution utilizing an aerosol system to dispense solutions with greater volume control.

It is yet another object of this invention to provide an applicator for an antimicrobial solution having touch or finger-pressure control over the dispensation of the antimicrobial solution.

It is yet another object of this invention to provide an applicator with a multiple use aerosol container having variable size and shape applicators for use at dedicated locations on a patient, which include but are not limited to, the inter-digital region, the eyes, and the pubic area.

The applicator for an antimicrobial solution of this invention includes an aerosol container and an applicator pad assembly having a hollow arm. The hollow arm has a proximal end attached to an aerosol cap and a distal end having a flanged arm plate to receive a foam applicator pad. The aerosol cap is removably attached to the aerosol container. A solution flow control is in communication with the aerosol container for selectively dispensing the antimicrobial solution. The aerosol container holds the antimicrobial solution under pressure and flow is controlled by a pressure sensitive flow control tab. The control tab activates the flow of the antimicrobial solution from the aerosol container through the hollow handle to the foam pad and then to the patient. The control tab may be actuated by touch or by pressure applied to the applicator pad. An optional flow control feature, in addition to the control tab, is a slit formed in the foam pad. The slit is designed so that it remains closed when no pressure is exerted on the distal surface of the foam pad. However, when pressure is exerted on the distal surface of the foam pad, such as when the applicator is pressed against a patient's skin, the slit opens to allow the antimicrobial solution to flow past the slit into the foam pad. There the antimicrobial solution can be easily distributed over the patient's skin by the foam pad. When a sufficient amount of the antimicrobial solution has flowed into the foam pad, the healthcare professional can release the pressure sensitive control tab to stop the flow of antimicrobial solution out of the aerosol container. In a preferred embodiment, the applicator pad consists of an open cell polyurethane or other foam like material with a woven or non-woven material lamination on the applicator side. This laminated layer could be a non-woven, permeable fibrous material with enough flow restriction to cause the solution to fill the channels before sufficient pressure is generated to force the solution through the laminated surface material and into the open cell foam pad. The channels can then act as a manifold with constant pressure to provide even solution dispersion into the sponge pad. The laminated layer could also be any non-permeable layer with a pattern of small holes or passages to restrict the flow, thereby, distributing the solution through the channels allowing even distribution of solution into the sponge pad. In a preferred embodiment, the foam applicator pad is bonded to the flange with glue, heat, flame, solvent, ultrasonic welding, or other appropriate methods. The bond area should enclose the channel pattern to contain the solution within the bond area and force the solution through the channels. The bond area could also extend between channels to further guide the solution flow through the channels

These and other objects and advantages of the present invention will become apparent from the subsequent detailed description of the preferred embodiment and the claims taken in conjunction with the accompanying drawings.

### 4. BRIEF DESCRIPTION OF THE DRAWINGS

The preferred embodiments are illustrated in the drawings in which like reference numerals refer to like elements and in which:

FIG. 1 is an elevated perspective view of the applicator of this invention;

FIG. 2 is an identical view of the invention as shown in FIG. 1 with the applicator assembly pad detached from the aerosol container;

FIG. 3 is a side cut-away view of the applicator pad assembly;

FIGS. 4(a)-(j) are top plan views of various geometric shapes that may be used for the face of the foam pad used on the applicator of this invention;

FIG. 5 is a side view of the applicator of this invention illustrating the same applicator container with two different size applicator pad assemblies

FIG. 6 is a side view of the applicator of this invention illustrating the same applicator pad assembly with different size containers;

FIG. 7 is an elevated perspective view of a pressure activated applicator;

FIG. 8 is an identical view of the invention as shown in FIG. 7 with the applicator assembly pad detached from the aerosol container;

FIG. 9 is a side cut-away view of the applicator pad assembly illustrating the slit feature to prevent unwanted solution flow;

FIG. 10 is a perspective view of the applicator pad showing a single cross-pattern slit positioned in the center of the applicator pad;

FIG. 11 is a profile view of the applicator pad illustrating the curvature of the foam pad;

FIG. 12 is an elevated perspective view of a lay-flat applicator design illustrating the direct connection between the aerosol container and the flange;

FIG. 13 is an identical view of the invention as shown in FIG. 12 with the applicator assembly pad detached from the aerosol container;

FIG. 14 is an exploded perspective of the lay-flat applicator pad assembly illustrating the laminated layer sandwiched between the flange and the applicator pad;

FIG. 15 is a side cross sectional view of the applicator pad assembly illustrating the position of the channels relative to the flange and applicator pad;

FIG. 16 is a profile view of the lay-flat applicator showing the applicator pad assembly in cross section.

FIG. 17 is a top plan view of the laminated layer;

FIG. 18 is an elevated perspective view of a lay-flat applicator;

FIG. 19 is an elevated perspective view of the lay-flat applicator as shown in FIG. 18 with the aerosol container removed;

FIG. 20 is an elevated perspective view of the lay-flat applicator with flange, laminated layer and applicator pad shown in and exploded view.

### 5. DETAILED DESCRIPTION OF THE INVENTION

As used herein, the term “proximal” refers to a location on the applicator for an antimicrobial solution of this invention that, during normal use, is closest to the clinician using the device and farthest from the patient in connection with whom the device is used. Conversely, the term “distal” refers to a location on the applicator of this invention that, during normal use, is farthest from the clinician using the device and closest to the patient in connection with whom the device is used.

As used herein, the term “top”, “up” or “upwardly” refers to a location on the applicator for an antimicrobial solution of this invention that, during normal use, is radially away from the device and away from the patient's skin. Conversely, as used herein, the term “bottom”, “down” or “downwardly” refers to a location on the applicator of this invention that, during normal use, is radially away from the device and toward the patient's skin.

As used herein, the term “in” or “inwardly” refers to a location with respect to the applicator for an antimicrobial solution of this invention that, during normal use, is toward the inside of the device. Conversely, as used herein, the term “out” or “outwardly” refers to a location with respect to the applicator of this invention that, during normal use, is toward the outside of the device.

Although the applicator of this invention is described for use with an alcohol-based antimicrobial prep solution, it is to be understood that any liquid antimicrobial prep solution may be used with the applicator.

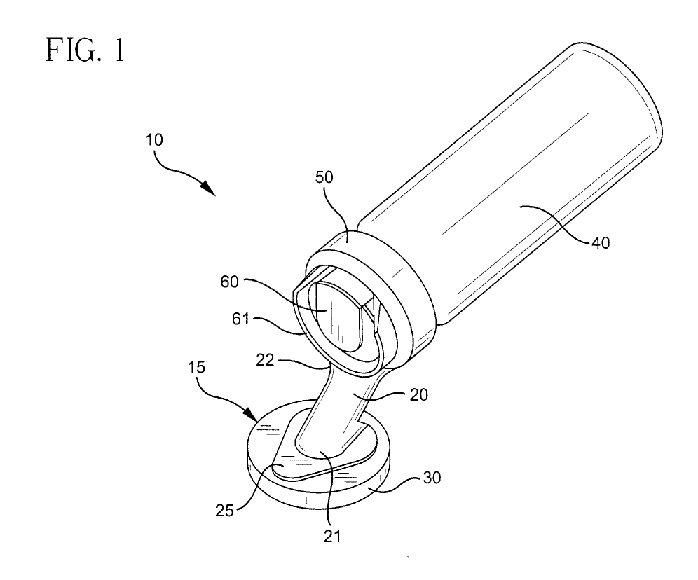

Referring now to the drawings and in particular to FIG. 1, the applicator 10 for an antimicrobial solution of this invention includes hollow arm 20 having an open proximal end 22 and an open distal end 21, and an applicator pad such as foam pad 30 attached to hollow arm 20 over the open distal end 21. In a preferred embodiment, the distal end 21 of hollow arm 20 ends in flange 25. Flange 25 is designed to accommodate various applicator pads, of various shapes and sizes, while providing a rigid surface area in which to apply the applicator pad 30. The applicator pad assembly 15 consists of flange 25 with foam pad 30 attached, hollow arm 20, aerosol cap 50, flow control tab 60, and flow control guard 61. The foam pad 30 is adhered to the flange portion 25 of hollow arm 20 by adhesive, flame bonding, ultrasonic weld, or other appropriate assembly methods. The face of foam pad 30 can have any shape desired. It can have a generally square or rectangular shape, a trapezoidal shape, a pentagonal shape, a circular shape, an elliptical shape or a triangular shape. The foregoing examples are illustrative only and in no way limit the invention.

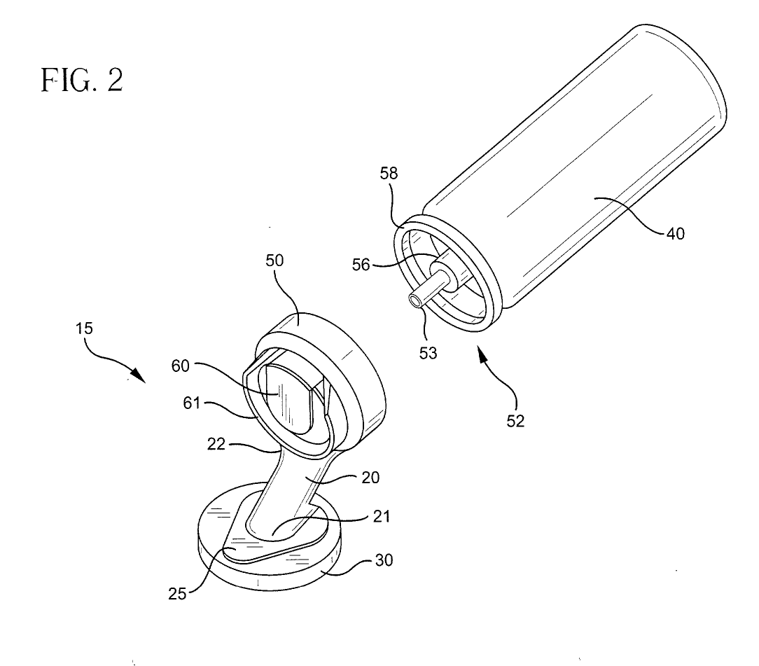

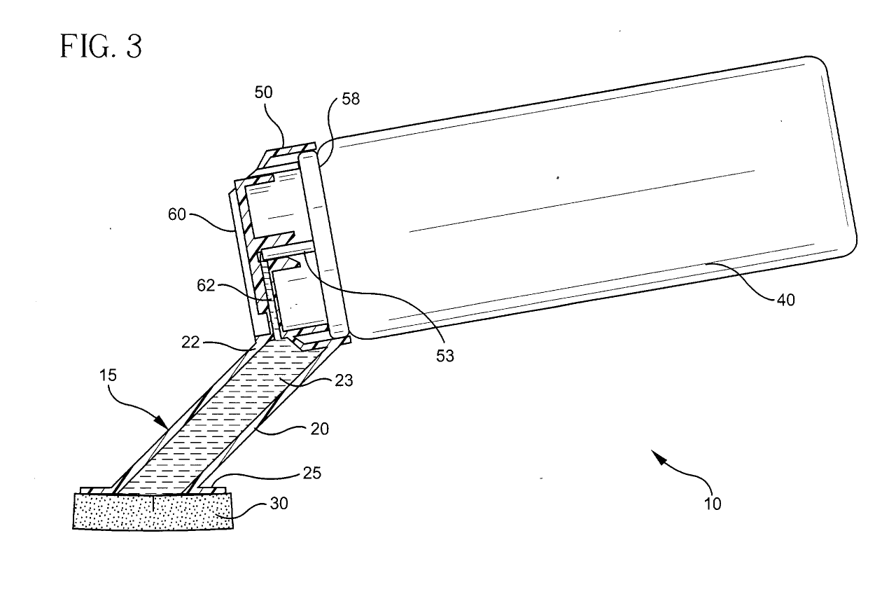

Turning now to FIG. 2, the open proximal end 22 of hollow arm 20 is connected to aerosol cap 50 creating a one-piece applicator pad assembly 15. The interior 23 of hollow arm 20, best seen in FIG. 3, is in direct communication with aerosol container 40 through valve assembly 52, as shown in FIG. 2. The valve assembly 52 consists of a stem 53, housing 56, mounting cup 58, and an actuator, such as control tab 60. The valve stem assembly 52 is further comprised of typical valve stem components including stem gasket 54, spring 55, and dip tube 57 (not shown). These unseen components allow the pressurized solution to escape from the container into hollow arm 20. In a preferred embodiment, the aerosol cap 50 friction fits over mounting cup 58 providing a snug connection between the applicator pad assembly 15 and the container 40. FIG. 3 shows the same applicator revealing similar valve components as described in FIG. 2. Valve assembly 52 is actuated by depressing flow control tab 60. Actuating valve assembly 52 allows the contents of aerosol container 40 to flow through flow tunnel 62, into the interior 23 of hollow arm 20 before reaching applicator pad 30. The volume of solution that could potentially collect in the applicator pad assembly 15 should be approximately equal to the volume of solution the foam pad 30 can absorb. It is preferred that the molded applicator pad assembly 15 should be a natural, or clear material such as high density polyethylene, polypropylene, polyamide, polyimide, ABS, PVC, polycarbonate or the like, for visual identification of the level of fluid held above the foam pad. Numerous types of applicator pad assemblies 15 could be manufactured and assembled with a variety of foam pads 30 depending on the prep location or the total area required to prep.

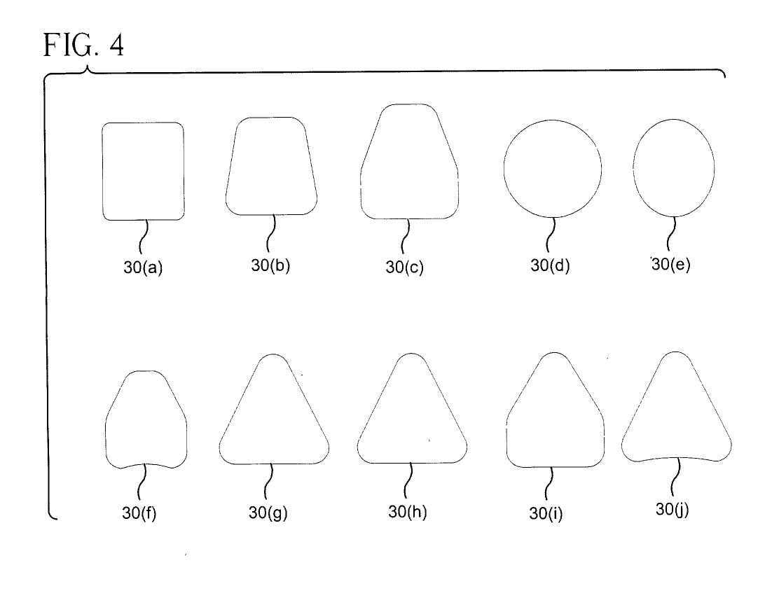

FIG. 4 illustrates the different foam pad geometries 30(a)-(j) that could be used depending on the application. A small applicator pad 30 is available for use in confined spaces, specifically, between fingers, toes, on the head, near eyes or ears. Applicator pads such as 30(f)-30(i) are designed for this purpose. The sharper edges of these particular geometries make them ideal for parting digits or ears from the feet, hands, or head. The sharper edges are also ideal for cornering around more sensitive areas such as the eyes, mouth, genitals and navel area. Larger applicator pads 30 are available for abdominal or other large prep areas. Broader more obtuse pads, 30(a)-30(e) are suitable for these applications

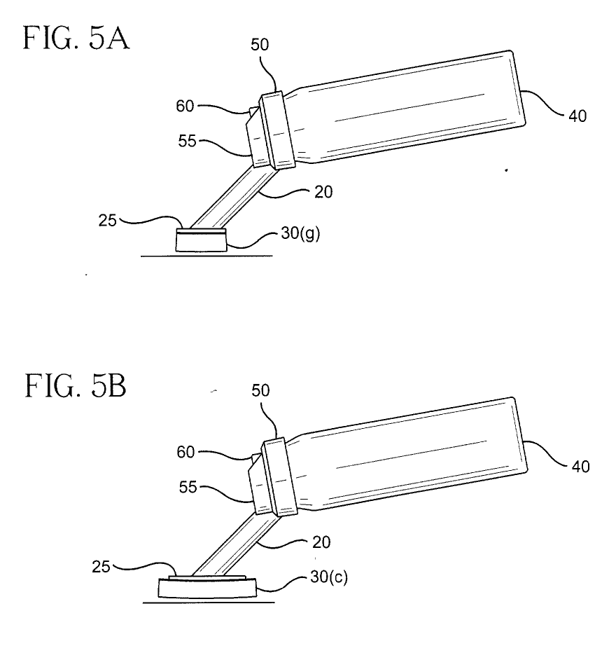

FIG. 5 illustrates the interchangeable use of small applicator pad 30(i) and larger pad 30(c) between the same applicator pad assembly 15 and aerosol can 40. Because the applicator pad assemblies 15 are interchangeable, the aerosol containers do not have to be a single use item. The applicator pad assembly 15 can simply be removed, disposed of, and a new one attached. Consequently, large size aerosol containers 40 can be used as multiple use solution containers, while the applicator pad assemblies 15 remain disposable single use components. Contamination that might arise from repeated use of large size-multiple use containers is not likely because the container is highly pressurized and the solution is antimicrobial in nature.

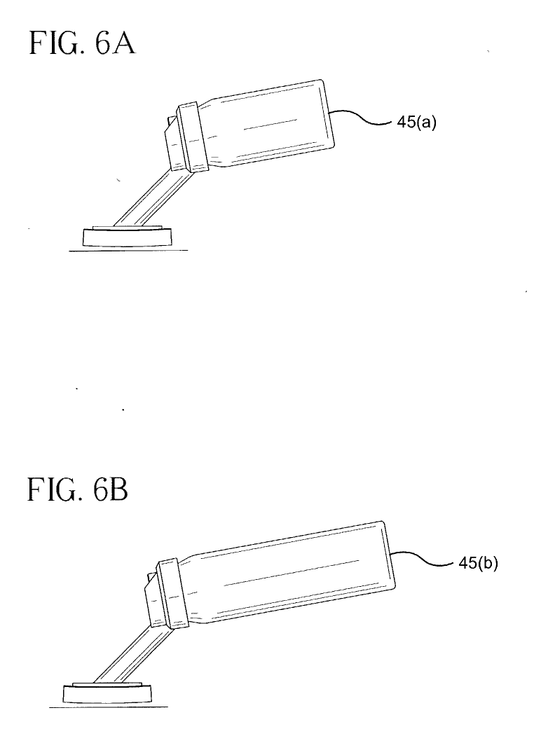

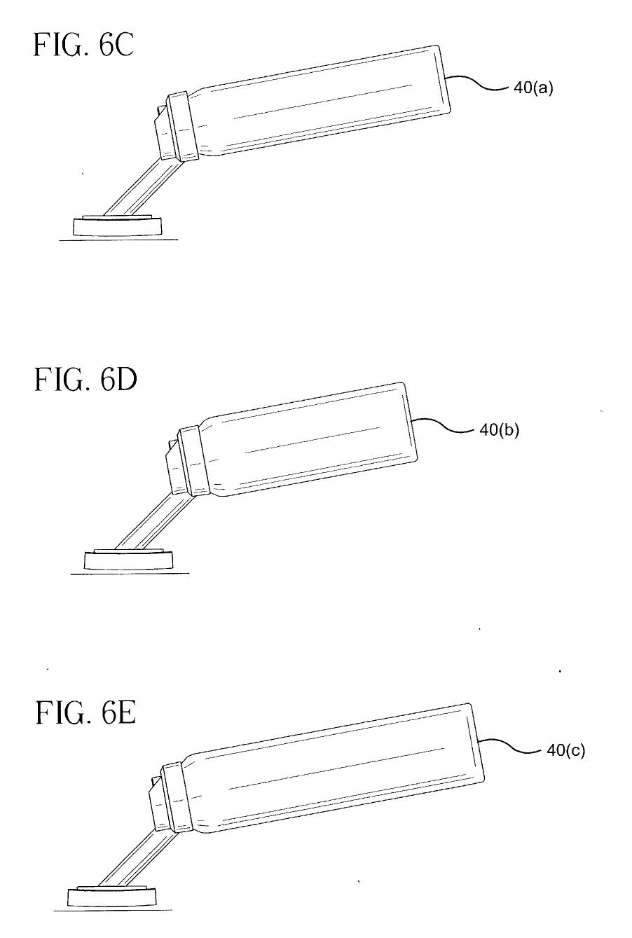

Turning to FIG. 6, several different size aerosol containers representing single use containers 45(a),(b) and multi-use containers 40(a),(b),(c) are presented, each having the same applicator pad assembly 15. Each of the different size containers 40, 45 can be used with the same size applicator pad assembly 15 resulting in a number of product offerings using much of the same components. In the alternative, aerosol containers can be sized to be a single use 45 or a multiple use 40 item, offered with multiple applicator pad assemblies 15. The container 40 should be available in 3-125 mL sizes depending on the procedure and the total prep area. Regardless of size or the number of applicator pad assemblies 15, the aerosol containers 40 do not have to be a single use item because the aerosol container 40 can be used as a multiple use solution container while the applicator pad assemblies 15 remain disposable single use components. This is particularly true in the present invention because the container is highly pressurized and the solution is antimicrobial in nature. (The solution containing aerosol container may be repeated use while the patient contacting applicator pad is single use and would be sterilized.)

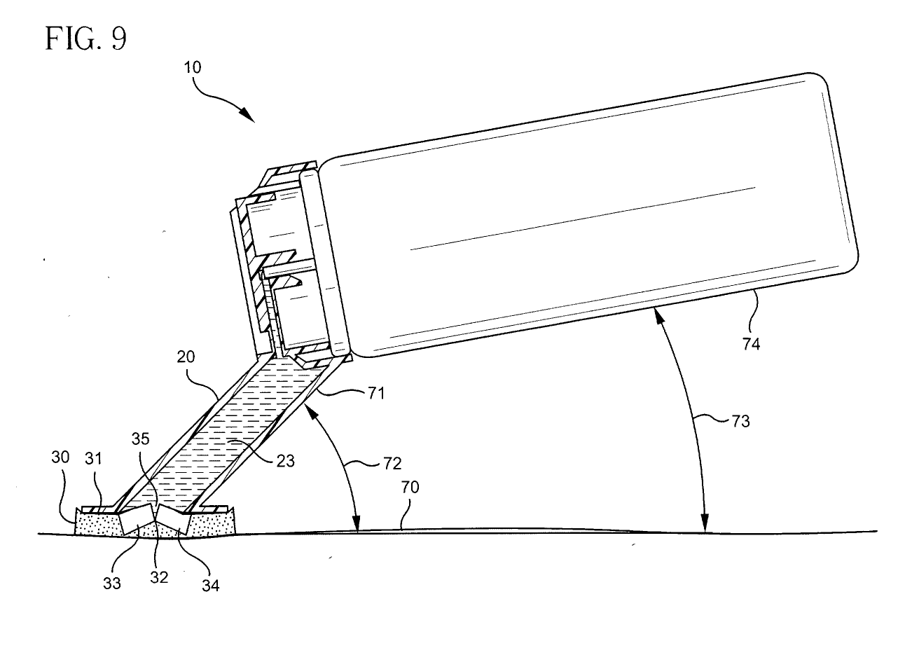

A means to control flow is especially important for a skin prep applicator dispensing a flammable solution, such as an alcohol based antimicrobial solution. The importance of flow control increases as the amount of dispensable solution increases. Aerosol dispensers 40, shown in FIG. 1, provide excellent flow control and solution dispensing rate control. The solution is dispensed by finger pressure on the flow control 60 or by pad pressure when the applicator pad 30 is in contact with the prep surface. Both of these aerosol systems can dispense a liquid or a foamed solution depending on the valve components used. The solution can be directed into a foam pad 30 of the applicator 10 for dispersal on the prep area or directly onto the prep area as a foam or spray. Foamed solutions have the advantage of not running, dripping or pooling and is therefore safer with regard to fire hazards during use and after disposal of the aerosol container 40. The aerosol system can be a traditional aerosol system with propellants, or more preferably, a non-propellant system such as CCL Industries Advanced Barrier System (ABS), which is disclosed in U.S. Pat. No. 5,137,186 incorporated herein by reference. The ABS system provides total separation of product (antimicrobial solution) and propellants delivering only pure product. Regardless, of the type of aerosol system, a small amount of solution will collect in the applicator pad assembly 15. If required, an additional flow control mechanism can be added as illustrated in FIG. 9.

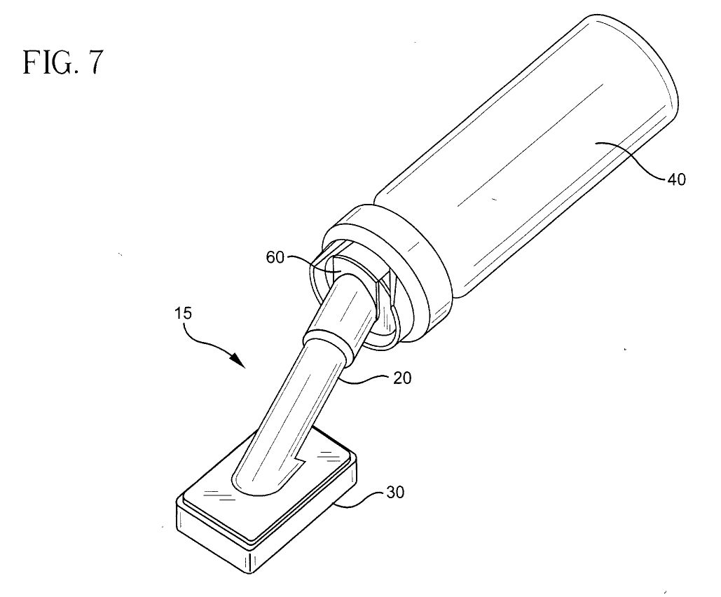

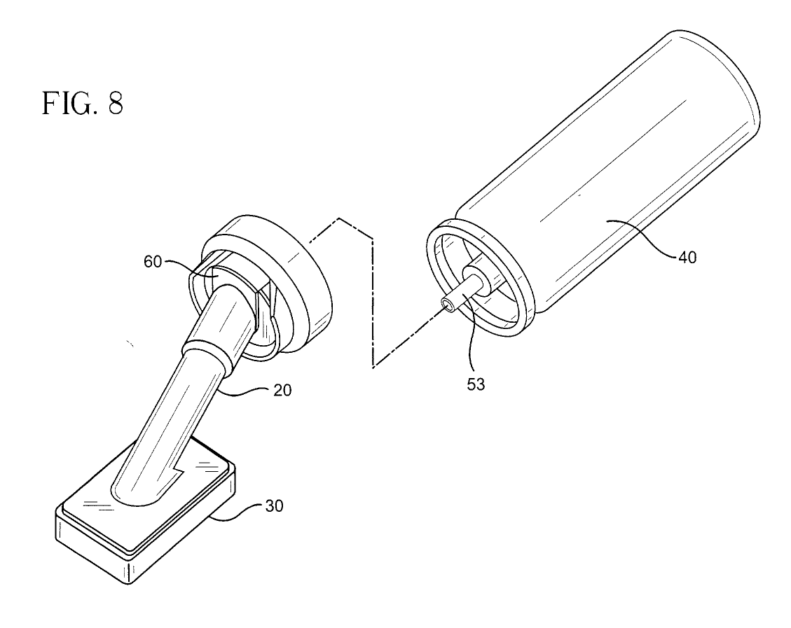

FIGS. 1 and 7 illustrate two alternative applicator pad assemblies 15 used to actuate the valve assembly 52 in the present invention. In a preferred embodiment the user can apply “touch” pressure to the flow control tab 60 using the applicator 10 as shown in FIG. 1. The flow control tab 60 is pivotally attached to the aerosol cap 50 near the proximal end 22 of hollow arm 20. The flow control 60 has a range of motion that allows the user to vary the touch pressure to control the rate of solution flow from the container 40 to the applicator pad 30. This gives the user more control and prevents inadvertent dispensing of the solution. An alternative embodiment, illustrated in FIG. 7, uses the pressure generated when the applicator pad 30 is pressed against a patient's skin to actuate the flow of solution from the container 40. The applied pressure forces the hollow arm 20 to pivot downward, which in turn actuates the flow control tab 60 during the course of prepping an area on a patient's skin. As shown in FIG. 8, the actuation of flow control tab 60 applies pressure to valve stem 53 thereby dispensing solution.

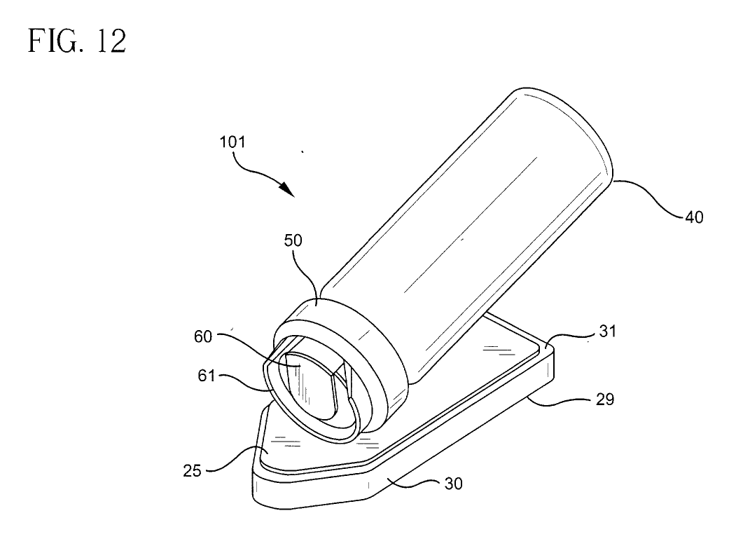

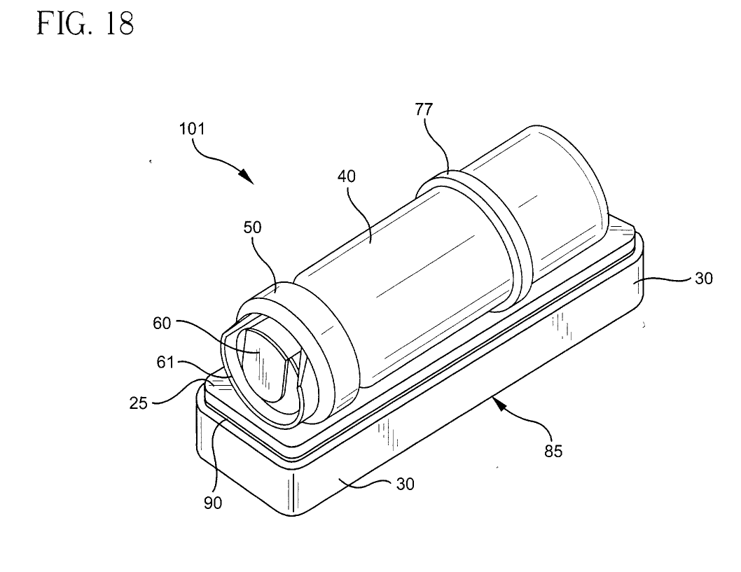

Hollow arm 20 can take any configuration desired. However, there are two preferred designs, a dual angle applicator 10, as illustrated in FIGS. 1 and 7, and a lay-flat design as shown in FIGS. 12 and 18 where the hollow arm 20 is replaced altogether with a direct connection from the aerosol cap 50 to the flange 25.

Turning now to FIG. 9 the preferred angle 72 of the portion of the applicator 10, which is adhered to the applicator pad 30, is about forty-five degrees as measured from hollow arm line 71 to the horizontal prep surface 70. This angle 72 changes to a second angle 73 between about ten and fifteen degrees from the horizontal 70 for the container portion 74 that serves as grip for applicator 10. Preferably, hollow handle 20 is formed from a transparent or translucent polymer. Since most prep solutions are colored with a dye or naturally are brown, such as iodine, this feature will allow the clinician to easily determine the amount of antimicrobial solution remaining in hollow handle 20.

FIG. 9 shows foam pad 30 having slit 32 that acts as a flow control valve to control the flow of dispensed antimicrobial solution from hollow handle 20 to foam pad 30 and then to the preparatory surface 70. As depicted in FIG. 9, slit 32 is designed so that it remains closed when no pressure is exerted on the distal surface of foam pad 30. The slit 32, as shown, does not extend the length of the applicator pad 30, but rather extends through the top portion of the pad 31 and terminates about midway into foam pad 30. The slit 32 creates forward flap 33 and rearward flap 34. When pressure is exerted on the distal surface of foam pad 30, such as when applicator 10 is pressed against a patient's skin 70, flaps 33 and 34 open to the interior 23 of hollow arm 20 to create gap 35. Gap 35 allows the antimicrobial solution to flow past slit 32 into foam pad 30. There the antimicrobial solution can be easily distributed over the patient's skin 70 by foam pad 30. When a sufficient amount of the antimicrobial solution has flowed into foam pad 30, the clinician can release the pressure exerted on the distal surface of foam pad 30 to stop the flow of antimicrobial solution out of hollow handle 20.

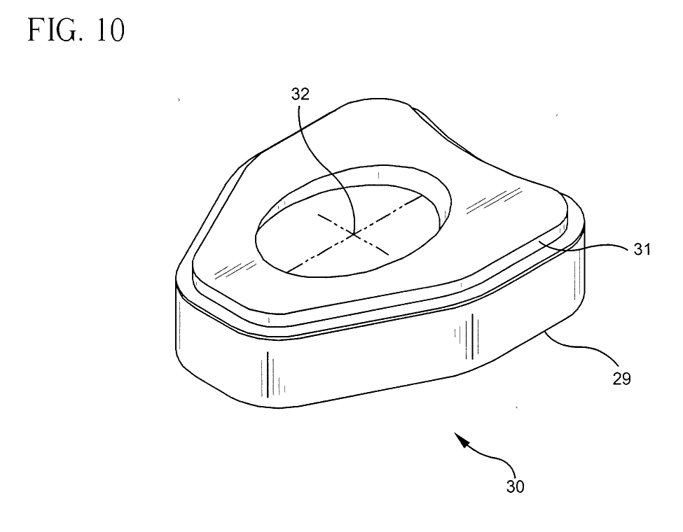

Turning to FIG. 10, foam pad 30 is preferably comprised of a single or multiple layered laminated material. The top layer 31 is preferably a substantially non-porous, hydrophobic material such as polyethylene, polypropylene, silicone, or other plastic material. Such a material substantially limits the flow of antimicrobial solution into the bottom layer 29. Preferably, the bottom layer 29 is an open cell foam, such as polyurethane or other suitable open cell foam or non-woven material, that allows the antimicrobial solution to pass through. Alternatively, foam pad 30 can be formed from a single layer of foam. In such a case, the top portion 31 of foam pad 30 preferably is less porous (more dense) than the bottom portion 29 of foam pad 30. The varying porosity can be achieved by a number of different techniques. For example, the top portion 31 of foam pad 30 can be flame treated or a thin layer of adhesive can be applied over the top portion of foam pad 30. In addition, foam pad 30 can be curved so the center of the radius of curvature is located proximally to the top portion 31 of foam pad 30. This arrangement restricts or closes the open cell structure along the top portion of foam pad 30. With any of the foregoing techniques, the flow of antimicrobial solution from hollow handle 20 into the bottom portion 29 of foam pad 30 is reduced.

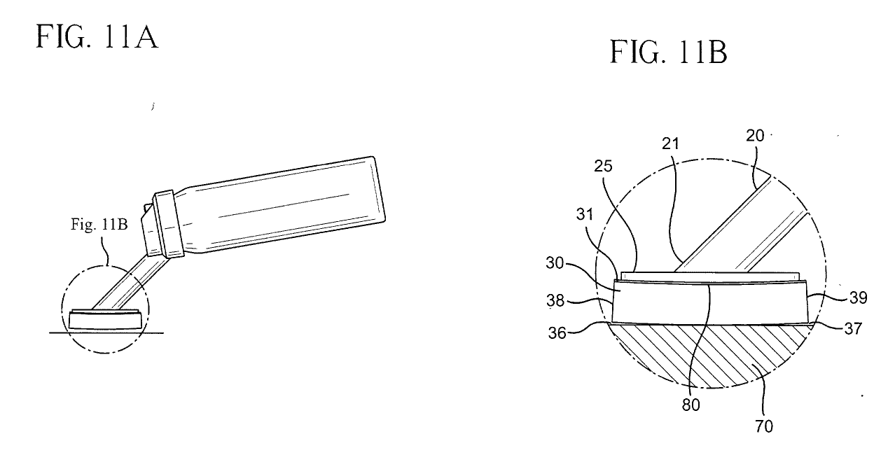

Turning to FIG. 11, slit 32 remains closed as long as foam pad 30 of applicator 10 is not pressed onto some surface, such as a patient's skin 70. In order to ensure that slit 32 remains closed under these circumstances, foam pad 30 is preferably curved creating forward spacing 36 and rear spacing 37. Preferably the spacings 36, 37 are such that the forward end 38 and rear end 39 of foam pad 30 are offset a particular distance from the middle 80 of foam pad 30. This offset distance can be correlated to the thickness of foam pad 30. Preferably the curvature of foam pad 30 is such that the offset distance is between t/12 and t/4 where t is the thickness of the foam pad. Attaching foam pad 30 to flange 25 having the desired curvature facilitates the provision of the appropriate curvature to foam pad 30.

Once foam pad 30 is pressed onto a patient's skin 70, slit or slits 32 opens allowing antimicrobial solution to flow into the open cells of foam pad 30. Thereafter, the antimicrobial solution can be dispersed in a controlled manner over the desired patient skin surface area 70. The curvature of foam pad 30 also increases patient comfort. This is because foam pad 30 will move more smoothly over an uneven surface since there is a reduced likelihood that an edge of foam pad 30 will catch on the patient's skin.

Thus it is seen that an applicator for an antimicrobial prep solution is provided that controls the amount of the solution that flows from the applicator, that allows the user to stop the flow of solution when desired and that allows the solution to remain in the applicator and or the aerosol container after some of the solution has been dispensed for subsequent use or disposal.

Turning now to FIG. 12, a second applicator design, such as lay-flat design, 101 is presented where the aerosol container 40 is substantially parallel with the applicator pad assembly 15. The lay-flat applicator 101 is particularly well-suited to accommodate full-length or partial-length applicator pads 30. The aerosol container 40 and the flow control 60 are typical in their design. However, the lay-flat applicator 10 has direct communication with the flange 25 to gain the necessary leverage to move the larger applicator pad 30. The flange 25 and the top of the applicator pad 31 are in intimate contact as shown.

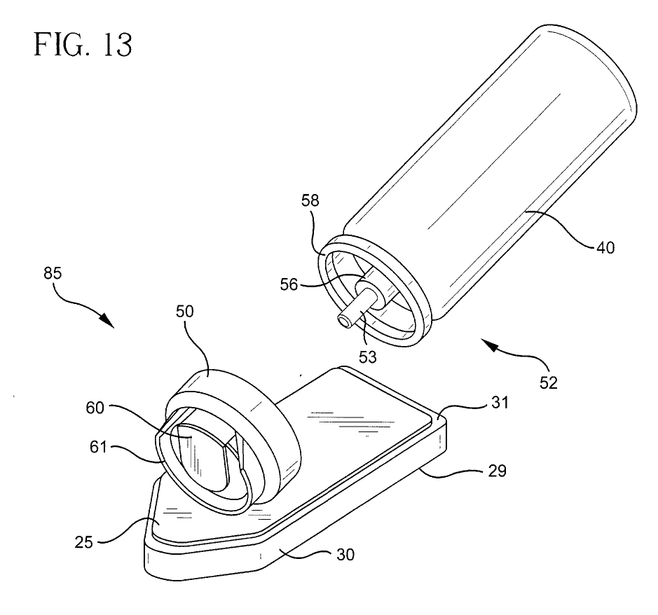

FIG. 13 shows the lay-flat applicator with the aerosol container 40 removed. The mounting cup 58 snugly fits the container 40 into the applicator pad assembly 15 by friction fitting with the aerosol cap 50 which is attached to the flange as a single piece. The valve stem 53 and the valve stem housing 56 fit into the aerosol cap 50 such that depressing flow control 60 acctuates the flow of antimicrobial foam or solution directly into the applicator pad 30.

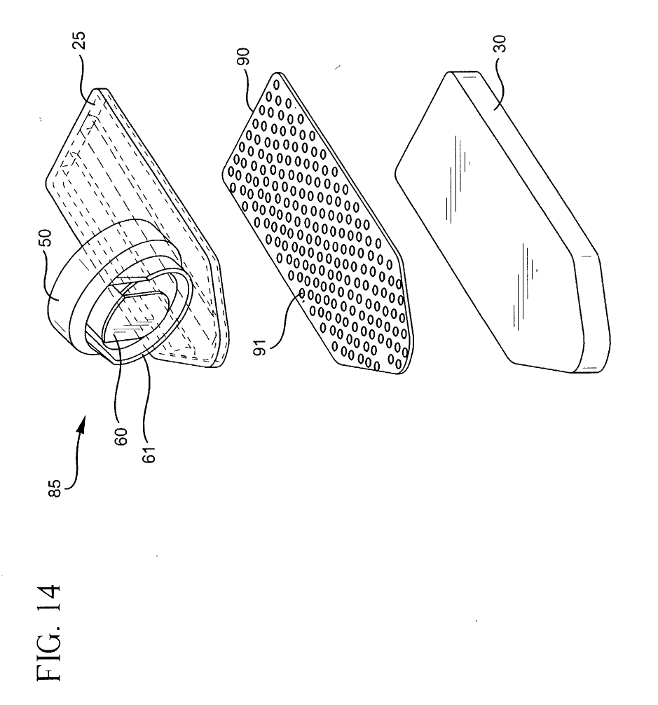

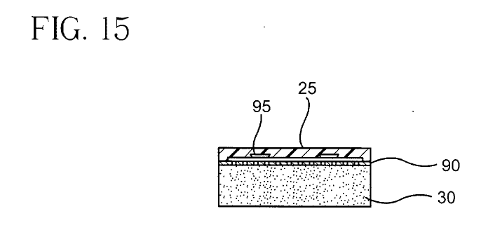

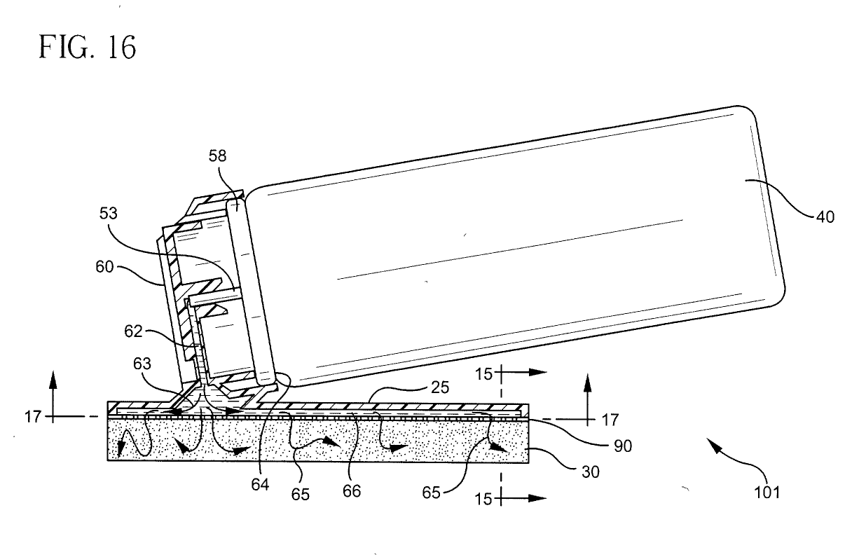

FIG. 14 presents a unique lay-flat applicator pad assembly 85. The pad assembly 85 has aerosol cap 50 directly attached to flange 25. Flange 25 has channels 95 that course through the patient side 100 of flange 25. The channels 95 can be arranged in a wide variety of patterns depending on the applicator pad geometry and will provide a more even distribution of solution through the applicator pad 30. This decreases the potential for solution pooling and dripping. The channels 95, best seen in FIG. 15, are designed to spread the antimicrobial solution over the length of the applicator pad 30. It is also possible to use a single slit 32 in the applicator pad 30, as shown in FIG. 10 or a plurality of holes formed in applicator pad 30 to be used as a secondary flow control. Where one slit 32 is used, as in FIG. 10 it is preferably aligned on an axis of the face of foam pad 30. If a plurality of slits 32 are used, the slits 32 can radiate out in any direction from the center of the face of foam pad 30. The slits 32 do not have to be straight but could be angled, curved or undulating. Alternatively, the plurality of slits 32 could be formed as a plurality of short single or crossed lines aligned or randomly placed on the face of foam pad 30. The particular pattern of slits 32 that are used, as well as the foam density, the slit or hole depth and the geometry of the applicator pad 30 will affect the rate of flow of the antimicrobial solution. Again, the foregoing examples for the slit pattern are illustrative only and in no way limit the invention.

An additional feature of the flat applicator pad assembly 85 aids in the distribution of the antimicrobial solution over the length of the applicator pad 30. The pad assembly 85 uses a laminated layer 90 placed between the applicator pad 30 and the patient side 100 of flange 25. Laminated layer 90 is a woven or non-woven, permeable fibrous material with enough flow restriction to force the solution to fill the channels 95 before sufficient pressure is achieved to force the solution through the laminated layer 90 and into the applicator pad 30. The channels 95 can then act as a manifold with constant pressure to provide even solution dispersion in to the applicator pad 30. The laminated layer 90 could also be any non-permeable layer with a pattern of small holes 91 or passages to restrict the flow, thereby, distributing the solution through the channels 95 allowing even distribution of solution into the applicator pad 30.

A cross sectional view of the lay-flat applicator 101 shows the aerosol can 40 engaged with the flat applicator pad assembly 85. Valve stem 53 is actuated by flow control 60 to introduce antimicrobial fluid into flow tunnel 62. Arrows 63 and 64 show the antimicrobial solution flowing in either direction until sufficient fluid occupies the flange cavity 66 such that continued actuation of the valve stem 53 causes sufficient fluid pressure to be generated, forcing the solution into the applicator pad 30 as illustrated by arrows 65.

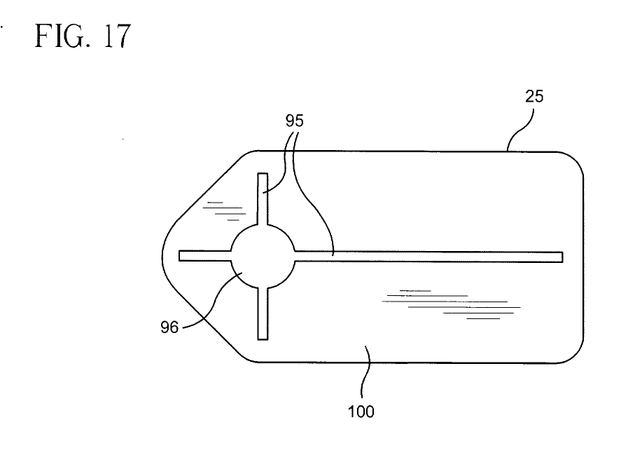

In a preferred embodiment the patient side 100 of flange 25 has channel access 96 that introduces antimicrobial solution into the flange cavity 66 (not shown). Channels 95 may extend laterally from the channel access point 96 in all directions. FIG. 17 is illustrative of this design, and shows four (4) channels 95 protruding form access point 96.

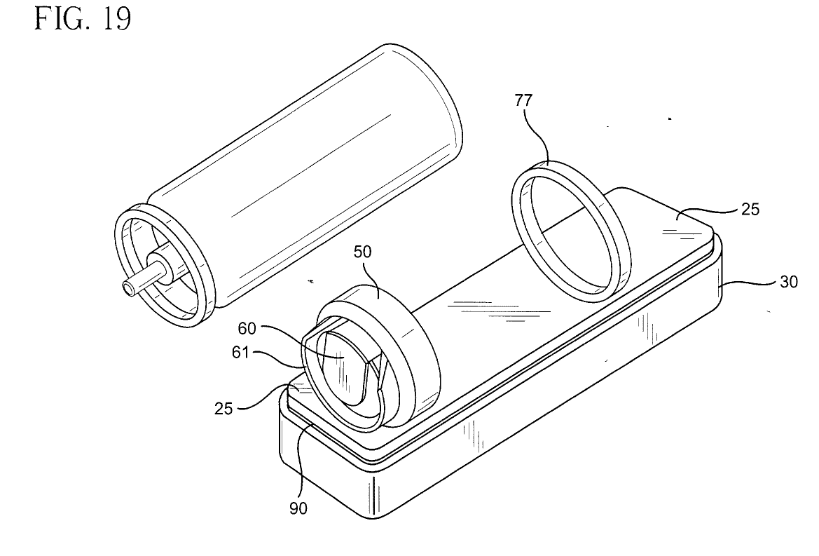

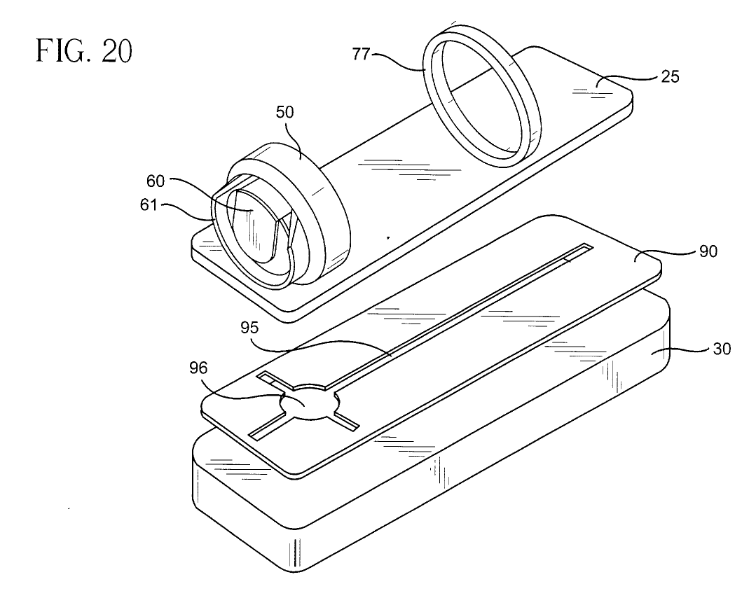

FIG. 18 illustrates an alternative lay-flat applicator 101 design where the aerosol container 40 is substantially parallel to the flat applicator pad assembly 85. The aerosol container is held in place through attachments at the aerosol cap 50 and guide ring 77. As shown in FIG. 19 the aerosol container is removable from the pad assembly 85. Flange 25 extends the length of the aerosol container 40 allowing the full length of the aerosol container to rest upon the flange 25 for stability. The guide ring 77 allows the healthcare professional to move the container 40 laterally without fear of disengaging the container 40 from the pad assembly 85. In a preferred embodiment the flange 25 is separated from the applicator pad 30 by laminated layer 90. The laminated layer 90 is best seen in FIG. 20 which illustrates a circular channel access 96 from which channels 95 extend. The channel access 96 routes incoming antimicrobial solution down the length of the various channels 95 to evenly distribute the antimicrobial solution before sufficient pressure is achieved in the flange cavity 66 to force antimicrobial solution into the applicator pad 30.

It will be apparent that the present invention has been described herein with reference to certain preferred or exemplary embodiments. The preferred or exemplary embodiments described herein may be modified, changed, added to, or deviated from without departing from the intent, spirit and scope of the present invention.

We claim:

1. An applicator comprising:
an aerosol container containing an antimicrobial solution;
an applicator pad assembly having a proximal end removably attached to the aerosol container and a distal end;
an applicator pad having a thickness, a center and an end portion; and
a solution flow control in communication with the aerosol container for selectively dispensing the antimicrobial solution.

2. The applicator of claim 1 wherein the distal end of the applicator pad assembly is flanged.

3. The applicator of claim 2 wherein the flanged distal end of the applicator pad is separated from the applicator pad by a laminated layer.

4. The applicator of claim 3 wherein the laminated layer contains channels to evenly distribute the antimicrobial solution into the applicator pad.

5. The applicator of claim 2 wherein the flanged distal end is curved.

6. The applicator of claim 1 wherein the applicator pad has a radius of curvature such that the center portion is offset from the end portion a distance having a value between the thickness divided by twelve and the thickness divided by four.

7. The applicator of claim 1 wherein the applicator pad has a substantially non-porous, hydrophobic top portion and a substantially porous open cell foam bottom portion.

8. The applicator of claim 7 wherein the applicator pad has at least one slit extending through the top portion into the bottom portion.

9. The applicator of claim 1 wherein said aerosol container is a non-propellant.

10. The applicator of claim 1 wherein the solution flow control is actuated by touch.

11. The applicator of claim 1 wherein the solution flow control is actuated by pressure applied to the applicator pad.

12. The applicator of claim 1 wherein said solution is an antimicrobial foam.

13. An applicator pad assembly for attachment to an aerosol container comprising:
a hollow arm having an open proximal end, an open distal end, and an interior portion;
an aerosol cap connected to the proximal end of the hollow arm;
a flow control pivotally attached to the aerosol cap and in communication with the aerosol container for transmitting the contents of an aerosol container through the interior of the hollow arm to the distal end of the hollow arm; and
a flange attached to the distal end of the hollow arm.

14. The applicator pad assembly of claim 13 wherein said applicator is substantially transparent.

15. The applicator assembly of claim 13 wherein said applicator is made from transparent polymers selected from the group consisting of high density polyethylene, polypropylene, polycarbonate, polyamide, polyacrylate, polyimide, ABS, and PVC.

16. The applicator assembly of claim 13 wherein said flange is curved.

17. The applicator of claim 13 wherein the flow control is actuated by touch.

18. The applicator of claim 13 wherein the flow control is actuated by pressure applied to the applicator pad.

19. An antimicrobial solution applicator for use with an aerosol container the applicator comprising:
a flange;
an aerosol cap connected to the flange for receiving an aerosol container;
a flow control pivotally attached to the aerosol cap and in communication with the aerosol container for selectively dispensing antimicrobial solution;
an applicator pad; and
a laminated layer positioned between the flange and the applicator pad for evenly distributing the antimicrobial solution into the applicator pad.

20. The applicator of claim 19 wherein a guide ring is attached to the flange to aid in stabilizing the aerosol container.

21. The applicator of claim 19 wherein the laminated layer contains channels to aid in distributing the antimicrobial solution over the applicator pad.

22. The applicator of claim 19 wherein the applicator pad has a substantially non-porous, hydrophobic top portion and a substantially porous open cell foam bottom portion.

23. The applicator of claim 19 wherein the solution flow control is actuated by touch.

24. The applicator of claim 19 wherein the solution flow control is actuated by pressure applied to the applicator pad.

25. The applicator of claim 19 wherein said solution is an antimicrobial foam.

26. A method for applying antimicrobial solutions comprising the steps of:
ejecting a volume of antimicrobial solution under pressure to an applicator pad, ejecting sufficient volume to saturate the applicator pad;
directing the applicator pad to an area to be disinfected; and
selectively ejecting additional antimicrobial solution to the applicator pad as necessary to cover the area to be disinfected.

27. A method as set forth in claim 26 wherein the ejection of antimicrobial solution is actuated by touch.

28. A method as set forth in claim 26 wherein the ejection of antimicrobial solution is actuated by pressure applied to the applicator pad.

29. A method as set forth in claim 26 wherein said antimicrobial solution is an antimicrobial foam.

30. A method as set forth in claim 26 wherein the applicator pad has a substantially non-porous, hydrophobic top portion and a substantially porous open cell foam bottom portion.

31. A method as set forth in claim 26 wherein the applicator pad has at least one slit extending through the top portion into the bottom portion.

32. A method as set forth in claim 26 wherein said aerosol container is a non-propellant.

33. A method as set forth in claim 26 wherein said antimicrobial solution enters a laminated layer before the applicator pad, to evenly distribute the antimicrobial solution over the applicator pad.
